(19) United States
(12) Patent Application Publication
(10) Pub. No.: US 2026/0319837 A1
(43) Pub. Date: Oct. 15, 2026

(54) DETERMINISTIC MULTI-AGENT ORCHESTRATION WITH COMPLIANCE AND PROVENANCE

(71) Applicant: George William Bickerstaff, III, Greenwich, CT (US)

(72) Inventor: George William Bickerstaff, III, Greenwich, CT (US)

(21) Appl. No.: 19/466,588

(22) Filed: Feb. 2, 2026

(51) Int. Cl. G06F 9/48

(52) U.S. Cl. CPC G06F 9/4881

(57) ABSTRACT

A deterministic multi-agent orchestration system intercepts actions, enforces adaptive multi-track compliance validation, controls processor registers and fused multiply-add behavior, generates Merkle-tree cryptographic execution receipts, and enables zero-knowledge replay verification with logarithmic computational complexity. The system provides bit-identical reproducibility, scalable auditability, and privacy-preserving verification across heterogeneous computing environments, delivering measurable improvements in latency, determinism, and regulatory compliance.

### TECHNICAL FIELD

The present invention relates generally to computer-implemented control architectures for artificial intelligence systems, distributed computing infrastructures, heterogeneous processor environments, and deterministic runtime governance. More particularly, the invention concerns deterministic multi-agent orchestration engines configured to intercept proposed computational actions prior to execution, enforce adaptive multi-track compliance validation with neuro-symbolic reflection, normalize execution behavior at the instruction-set-architecture level across diverse hardware platforms, generate cryptographically verifiable Merkle-tree execution receipts, and enable replay-verifiable outputs with logarithmic-time verification guarantees in federated and privacy-preserving environments. The invention provides a concrete technological improvement to the physical operation of computing systems by managing processor registers, cache affinity, deterministic scheduling, and cryptographic state validation to eliminate nondeterministic drift while simultaneously enabling scalable, privacy-preserving auditability and cross-jurisdictional compliance verification.

### BACKGROUND OF THE INVENTION

Modern computational ecosystems increasingly rely on coordinated collections of artificial intelligence models, analytic engines, and autonomous decision systems to perform complex tasks including financial analysis, medical diagnostics, supply-chain optimization, infrastructure management, and regulatory decision support. These multi-agent systems often operate across heterogeneous hardware platforms and multiple regulatory jurisdictions, introducing variability due to floating-point precision differences, fused multiply-add behavior, compiler optimizations, dependency drift, stochastic inference paths, and hardware non-idealities such as conductance decay or temperature-induced variance.

Existing orchestration frameworks emphasize routing, delegation, and scheduling of computational tasks but fail to guarantee deterministic reproducibility, scalable cryptographic auditability, and hardware-level normalization across diverse infrastructures. Conventional post-execution logging mechanisms are insufficient to prevent unsafe or non-compliant actions, and linear hash chains become computationally infeasible when reasoning pipelines exceed millions of micro-steps. These limitations produce operational risk, regulatory uncertainty, and diminished trust in automated reasoning systems.

Accordingly, there exists a need for a deterministic orchestration architecture that integrates instruction-set-level register control, adaptive compliance gating with neuro-symbolic reflection, scalable Merkle-tree provenance, privacy-preserving zero-knowledge verification, and replay validation while delivering measurable improvements in latency, reproducibility, security, and compliance readiness.

### SUMMARY OF THE INVENTION

The present invention provides a deterministic multi-agent orchestration system comprising an action intercept layer, a multi-track compliance gate, a hardware-ISA normalization runtime, a Merkle-tree cryptographic receipt engine, and a replay verification subsystem configured to enforce deterministic execution, logarithmic-time audit verification, and privacy-preserving compliance validation across heterogeneous and federated computing environments.

The system establishes an independent control plane governing execution through a canonical lifecycle of intercept, evaluate, authorize, execute, record, and verify operations. Processor register states, rounding modes, cache affinity, dependency versions, and deterministic seeds are locked prior to execution and restored during replay, thereby ensuring bit-identical reproducibility across hardware vendors and generations. Execution micro-states are bound into Merkle-tree structures enabling efficient verification of individual reasoning steps without full-chain traversal.

Measurable technical effects include deterministic equivalence across heterogeneous hardware, logarithmic verification complexity, reduced rollback frequency, and enhanced audit transparency while preserving sensitive data through zero-knowledge validation mechanisms.

### Definitions

ACTION INTERCEPT—A pre-execution capture mechanism that suspends a proposed computational action and enriches it with metadata including timestamps, identifiers, and policy vectors prior to evaluation.

MULTI-TRACK COMPLIANCE GATE—A parallel evaluation engine comprising static rule-based validation, adaptive risk scoring, and neuro-symbolic constraint verification operating concurrently to determine execution eligibility.

HARDWARE-ISA NORMALIZATION—Instruction-set-architecture-level alignment of processor registers, rounding modes, compiler flags, deterministic seeds, and dependency versions to eliminate cross-hardware variability.

MERKLE EXECUTION RECEIPT—A cryptographic Merkle-tree structure binding execution micro-states, timestamps, and policy outcomes into a tamper-evident provenance record.

FUSED MULTIPLY-ADD DETECTION—A mechanism for identifying and optionally emulating fused arithmetic instructions to prevent vendor-specific floating-point divergence.

ZERO-KNOWLEDGE PROOF—A cryptographic validation technique enabling verification of correctness or compliance without revealing underlying protected data.

POLICY VECTOR—A structured representation of compliance, safety, jurisdictional, fairness, and privacy rules with adjustable thresholds.

REPLAY VERIFICATION—Deterministic re-execution of computational steps using stored parameters and seeds to confirm output equivalence.

DETERMINISTIC RUNTIME—A controlled execution environment managing memory allocation, cache affinity, and scheduling order to ensure repeatability.

AUTHORIZATION TOKEN—A cryptographically signed permit embedding temporal and policy boundaries governing execution rights.

### DETAILED DESCRIPTION OF THE INVENTION

### Instruction-Set Register Control Layer

The system interfaces with processor control registers, including but not limited to MXCSR in x86 architectures and FPCR in ARM architectures, to enforce deterministic rounding modes, exception masking, and denormal handling. Register states are captured at the moment of action intercept and restored during replay verification. This mechanism ensures bit-identical floating-point behavior across heterogeneous hardware environments.

### Fused Multiply-Add Emulation Module

Hardware instructions performing fused multiply-add operations are detected through opcode inspection during compilation or runtime translation. When deterministic equivalence is required, the fused operation is replaced with discrete multiply and add steps using extended precision intermediates. This substitution prevents arithmetic drift caused by vendor-specific microarchitectural implementations.

### Merkle-Tree Receipt Engine

Execution micro-states are hashed into leaf nodes of a Merkle tree, with intermediate nodes formed by hashing pairs of child nodes until a single root hash is produced. The root hash is optionally signed with a quantum-resistant digital signature to bind the entire execution chain. Verification of any micro-state requires only a logarithmic-length proof path rather than full-chain traversal.

### Multi-Track Compliance Engine

The compliance engine evaluates proposed actions through three concurrent tracks: a static rule tree enforcing jurisdictional policies, an adaptive scoring model updated through historical feedback, and a neuro-symbolic validator translating probabilistic outputs into symbolic constraints for satisfiability testing. Cross-track escalation logic resolves conflicts and may trigger supervisory review or rejection.

### Virtualized Deterministic Runtime

Memory allocation, thread pinning, and cache affinity are managed to reduce nondeterministic variation arising from parallel scheduling or hardware interrupts. Deterministic seeds derived from hashed inputs ensure repeatable stochastic model behavior.

Zero-Knowledge Audit Layer

Compliance verification statements are encoded into arithmetic circuits and proven using zero-knowledge proof systems. Proofs attest to receipt inclusion and policy satisfaction while excluding raw data, prompts, or personally identifiable information.

### Replay Verification Engine

Deterministic replay reconstructs the original execution environment using stored inputs, parameters, and register states. Equivalence metrics compare outputs at bit-level granularity or bounded divergence thresholds to confirm deterministic integrity.

### BRIEF DESCRIPTION OF THE DRAWINGS

FIG. 1—SYSTEM OVERVIEW

FIG. 1A—CONTROL PLANE

This subfigure illustrates the separation between governance logic and execution agents to prevent unauthorized influence on runtime states. Secure communication channels are depicted to maintain isolation between policy enforcement and computational tasks. The design emphasizes fault containment and security integrity across distributed environments.

FIG. 1B—ACTION INTERCEPT

This subfigure shows prioritized queues capturing proposed agent actions before execution begins. Metadata enrichment layers attach timestamps, identifiers, and policy vectors for evaluation. The structure prevents race conditions and ensures deterministic ordering.

FIG. 1C—DETERMINISTIC RUNTIME

This subfigure depicts controlled memory allocation, cache affinity mapping, and deterministic seed management. Thread pinning and scheduling rules reduce nondeterministic variation. The architecture ensures repeatable execution across hardware classes.

FIG. 1D—REGISTER CONTROL

This subfigure illustrates direct interaction with processor control registers enforcing fixed rounding modes and exception masks. State capture and restoration mechanisms are highlighted. The diagram demonstrates hardware-level determinism.

FIG. 1E—FMA EMULATION

This subfigure shows detection of fused multiply-add instructions and substitution with discrete operations. Extended precision intermediates maintain equivalence across vendors. Arithmetic divergence is thereby prevented.

FIG. 2−COMPLIANCE ENGINE

FIG. 2A—STATIC TRACK

This subfigure depicts deterministic rule trees enforcing jurisdictional and safety constraints. Decision nodes provide transparent audit trails. The structure ensures hard compliance requirements.

FIG. 2B—ADAPTIVE TRACK

This subfigure illustrates weighted scoring models updated from historical feedback. Risk thresholds dynamically adjust to new data. Continuous learning integration is emphasized.

FIG. 2C—SYMBOLIC TRACK

This subfigure shows translation of probabilistic outputs into symbolic constraints for validation. Logical solvers confirm alignment with predefined rules. Deterministic safety overlays are highlighted.

FIG. 2D—ESCALATION LOGIC

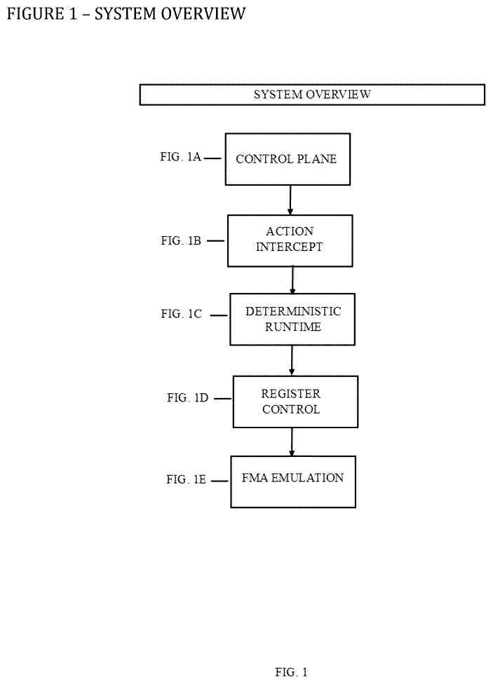

This subfigure depicts cross-track attention weighting and supervisory override pathways. High-risk signals trigger rejection or review. Hierarchical enforcement ensures safety.

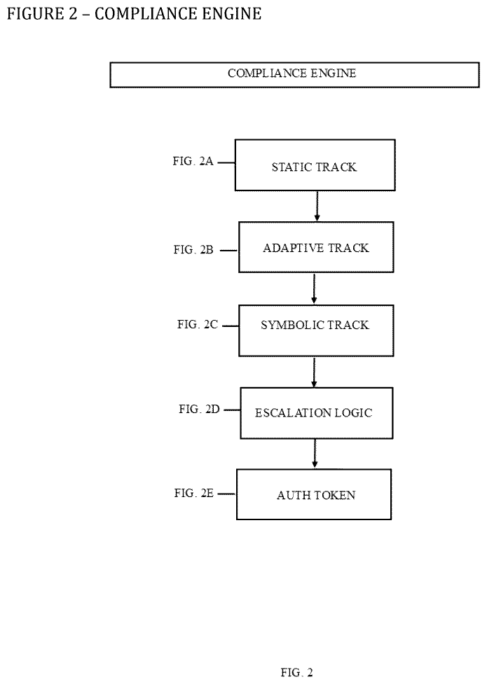

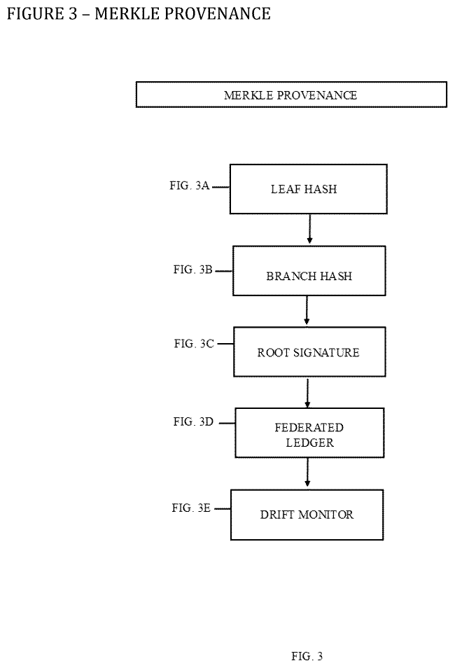

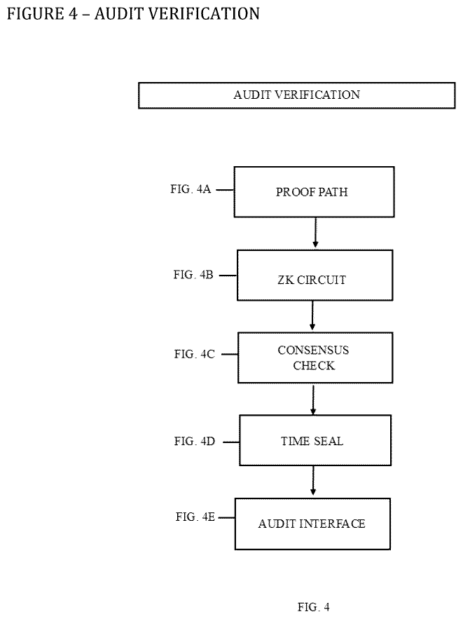

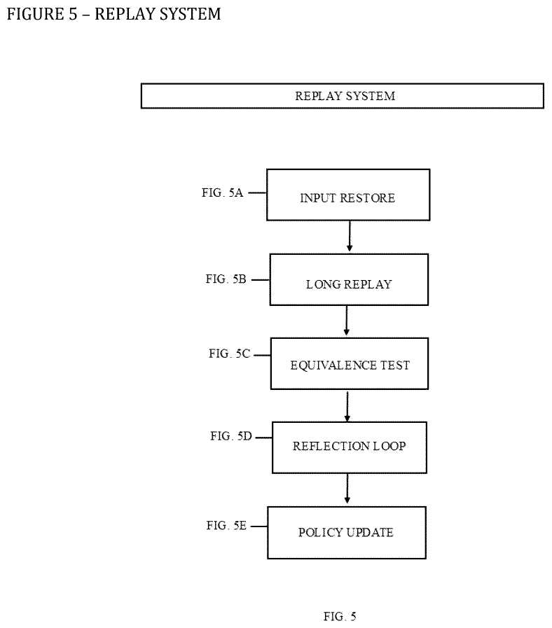

### FIG. 2E—AUTH TOKEN

This subfigure shows generation of cryptographically signed authorization tokens with temporal limits and revocation safeguards. Embedded policy hashes ensure tamper detection. Execution permissions are tightly controlled.

FIG. 3—MERKLE PROVENANCE

FIG. 3A—LEAF HASH

This subfigure illustrates hashing of execution micro-states into leaf nodes. Metadata such as timestamps and outcomes are included. Foundational integrity is established.

FIG. 3B—BRANCH HASH

This subfigure shows hierarchical aggregation of leaf hashes into intermediate nodes. Pairwise hashing ensures tamper evidence. Scalability is emphasized.

FIG. 3C—ROOT SIGNATURE

This subfigure depicts application of quantum-resistant signatures to the Merkle root. The signature binds the entire chain. Verification authority is illustrated.

FIG. 3D—FEDERATED LEDGER

This subfigure illustrates distributed append-only ledgers storing signed roots. Independent nodes verify authenticity. Multi-party trust is demonstrated.

FIG. 3E—DRIFT MONITOR

This subfigure shows dependency and configuration hash comparisons detecting environmental drift. Alerts trigger recalibration or quarantine. Execution integrity is preserved.

FIG. 4—AUDIT VERIFICATION

FIG. 4A—PROOF PATH

This subfigure illustrates extraction of logarithmic proof paths for single-step verification. Only necessary nodes are transmitted. Efficiency is demonstrated.

FIG. 4B—ZK CIRCUIT

This subfigure shows arithmetic circuits encoding compliance statements. Zero-knowledge proofs confirm correctness without exposing data. Privacy preservation is emphasized.

FIG. 4C—CONSENSUS CHECK

This subfigure depicts aggregation of federated signatures confirming receipt validity. Multi-party thresholds are illustrated. Distributed trust is ensured.

FIG. 4D—TIME SEAL

This subfigure illustrates cryptographic timestamping with synchronized clocks and nonces. Replay attacks are prevented. Chronological integrity is maintained.

FIG. 4E—AUDIT INTERFACE

This subfigure shows generation of human-interpretable compliance reports. Visual dashboards display verification outcomes. Transparency and usability are emphasized.

FIG. 5—REPLAY SYSTEM

FIG. 5A—INPUT RESTORE

This subfigure depicts reconstruction of original inputs and parameters from receipts. Deterministic seeds are restored. Fidelity is ensured.

FIG. 5B—LONG REPLAY

This subfigure illustrates deterministic re-execution of extended reasoning chains. Micro-validation checkpoints confirm continuity. Compounding error is prevented.

FIG. 5C—EQUIVALENCE TEST

This subfigure shows bit-level and statistical comparison metrics identifying drift. Divergence thresholds are visualized. Accuracy assurance is emphasized.

FIG. 5D—REFLECTION LOOP

This subfigure depicts symbolic constraint hints returned to agents after rejection. Automated correction cycles are illustrated. Alignment improves iteratively.

FIG. 5E—POLICY UPDATE

This subfigure shows adaptive threshold and normalization model updates based on telemetry. Feedback integration is visualized. Continuous improvement is emphasized.

### EXAMPLES

### Example 1—Financial Regulatory Audit

A trading platform intercepts proposed transactions, normalizes processor registers, evaluates compliance vectors, generates Merkle receipts, and enables regulators to verify outcomes through zero-knowledge proofs without exposing account data.

### Example 2—Medical Diagnostic Pipeline

A diagnostic AI pipeline compensates hardware drift, validates outputs against privacy policies, and performs deterministic replay to reproduce reasoning while preserving patient confidentiality.

1. A computer-implemented system comprising an action intercept module, a multi-track compliance gate, a hardware-ISA normalization runtime configured to control processor registers and detect fused multiply-add instructions, a Merkle-tree cryptographic receipt generator, and a replay verification engine configured to provide deterministic multi-agent execution and logarithmic-time audit verification.

2. A computer-implemented method comprising intercepting proposed computational actions, evaluating policy vectors through static, adaptive, and symbolic tracks, normalizing hardware parameters including processor registers and rounding modes, generating Merkle-tree execution receipts, and verifying execution deterministically using logarithmic proof paths and zero-knowledge validation.

3. A non-transitory computer-readable medium storing instructions that cause processors to perform deterministic orchestration including hardware-ISA normalization, compliance gating, Merkle-tree receipt generation, privacy-preserving verification, and replay validation. Claim 4. The system of claim 1 wherein processor registers are set to fixed IEEE 754 rounding modes.

5. The system of claim 1 wherein fused multiply-add instructions are emulated using discrete operations.

6. The system of claim 1 wherein analog non-ideality compensation employs adaptive correction matrices.

7. The system of claim 1 wherein compliance tracks employ cross-attention escalation thresholds.

8. The system of claim 1 wherein Merkle proofs enable logarithmic verification.

9. The method of claim 2 further comprising symbolic constraint hints for corrective feedback.

10. The system of claim 1 wherein zero-knowledge proofs validate compliance without exposing protected data.
